(19) United States
(12) Patent Application Publication
(10) Pub. No.: US 2016/0321768 A1
(43) Pub. Date: Nov. 3, 2016

(54) METHODS FOR MANAGING LEGAL DOCUMENTS AND DEVICES THEREOF

(71) Applicant: BrownGreer, PLC., Richmond, VA (US)

(72) Inventors: Orran L. Brown, SR., Richmond, VA (US); Orran L. Brown, JR., Richmond, VA (US); Jacob S. Woody, Richmond, VA (US)

(21) Appl. No.: 15/142,724

(22) Filed: Apr. 29, 2016

Related U.S. Application Data
(60) Provisional application No. 62/155,822, filed on May 1, 2015.

(51) Int. Cl. G06Q 50/18; G06F 17/30; G06F 21/62; G06Q 10/10

(52) U.S. Cl. CPC G06Q 50/18; G06Q 10/10; G06F 17/30011; G06F 17/30719; G06F 21/6218

(57) ABSTRACT

A method, non-transitory computer readable medium, and a document management computing device that assists with managing legal documents includes receiving data in a legal fact sheet from a consumer computing device. One or more supporting legal documents associated the received data in the fact sheet are also received. The received data in the legal fact sheet and the received one or more supporting legal documents are determined for completeness and accuracy based on review data received from the consumer computing device. A completion notification and a request for response to the data in the legal fact sheet is sent to the consumer computing device when the received data in the legal fact sheet and the received one or more supporting legal documents are determined to be complete and accurate.

This application claims the benefit of U.S. Provisional Patent Application Ser. No. 62/155,822, filed May 1, 2015, which is hereby incorporated by reference in its entirety.

### FIELD

This technology generally relates to data management, more particularly, to methods for managing legal documents and information and devices thereof.

### BACKGROUND

Document and information management is a critical process for nearly every organization, and particularly for a law firm. Generally law firms handle complex litigation matters which involve handling, and distributing a large number of legal and related documents and information. Therefore effective management, organization and utilization of such documents and information in an electronic format is extremely important.

Some conventional electronic systems and methods for managing, organizing, and utilizing legal documents and information focus solely on certain areas, and are not scalable or adaptable to manage large amounts of documents. Additionally, prior technologies do not index the legal documents that are stored and therefore results in very slow storing, and retrieving of legal documents and information. As a result, even the memory in the servers is not utilized efficiently which in turn reduces the performance of the server assisting with managing, organizing, and utilizing legal documents and information.

### SUMMARY

A method for managing legal documents and information includes receiving by the data management computing device data in a legal fact sheet or other questionnaire or survey from a consumer computing device. One or more supporting legal documents associated with the received data in the fact sheet are also received by the data management computing device. The received data in the legal fact sheet and the received one or more supporting legal documents are determined for completeness and accuracy by the data management computing device based on review data received from the consumer computing device. A completion notification and a request for response to the data in the legal fact sheet is sent to the consumer computing device by the data management computing device when the received data in the legal fact sheet and the received one or more supporting legal documents are determined to be complete and accurate.

A non-transitory computer readable medium having stored thereon instructions for managing legal documents and information comprising machine executable code which when executed by at least one processor, causes the processor to perform steps including receiving data in a legal fact sheet from a consumer computing device. One or more supporting legal documents associated with the received data in the fact sheet are also received. The received data in the legal fact sheet and the received one or more supporting legal documents are determined for completeness and accuracy based on review data received from the consumer computing device. A completion notification and a request for response to the data in the legal fact sheet is sent to the consumer computing device when the received data in the legal fact sheet and the received one or more supporting legal documents are determined to be complete and accurate.

A data management computing device comprising a processor, a memory, wherein the memory coupled to the processor which is configured to execute programmed instructions stored in the memory includes receiving data in a legal fact sheet from a consumer computing device. One or more supporting legal documents associated the received data in the fact sheet are also received. The received data in the legal fact sheet and the received one or more supporting legal documents are determined for completeness and accuracy based on review data received from the consumer computing device. A completion notification and a request for response to the data in the legal fact sheet is sent to the consumer computing device when the received data in the legal fact sheet and the received one or more supporting legal documents are determined to be complete and accurate.

This technology provides a number of advantages including providing more effective methods, non-transitory computer readable medium and devices for managing legal documents by electronically filing, exchanging, retrieving and storing documents in civil litigation, government investigations, and multiple-claimant matters. Additionally, the technology indexes the documents associated with the user account using the unique identification number which helps in efficiently storing and retrieving of the legal documents.

### BRIEF DESCRIPTION OF THE DRAWINGS

FIG. 1 is a block diagram of an exemplary document management computing device for managing legal documents;

FIG. 2 is an exemplary functional block diagram of the document management computing device;

FIG. 3 is an exemplary flowchart illustrating a method for processing plaintiff registration data;

FIG. 4 is an exemplary flowchart illustrating a method for registering legal documents users;

FIG. 5 is an exemplary flowchart illustrating a method for receiving a response from the defendant for a plaintiff fact sheet;

FIG. 6 is an exemplary flowchart illustrating a method for searching for case pleadings; and

FIG. 7 is an exemplary flowchart illustrating a method for processing discovery requests.

### DETAILED DESCRIPTION

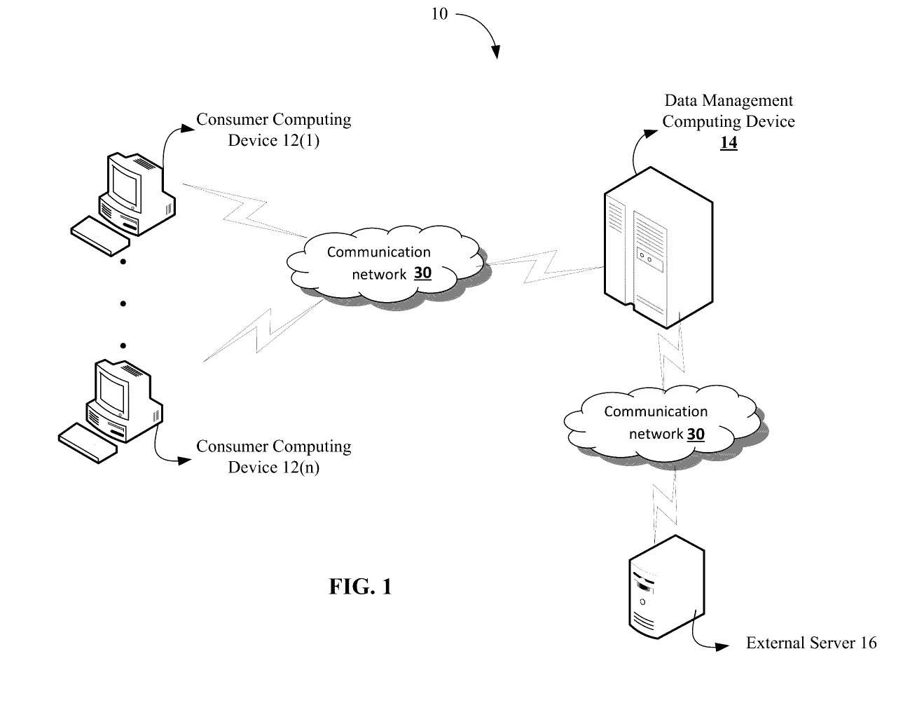

An exemplary environment 10 including a plurality of consumer computing devices 12(1)-12(n), a data management computing device 14, and an external server 16 for managing legal documents is illustrated in FIG. 1. The data management computing device 14 facilitates managing legal documents by electronically filing, exchanging, retrieving and storing documents in civil litigation, government investigations and multiple-claimant matters as illustrated and described with the examples herein, although the data management computing device 14 may perform other types and/or numbers of functions and in other types of networks. The exemplary environment 10 includes consumer computing devices 12(1)-12(n), the data management computing device 14, and the external server 16 which are coupled together by a communication network 30, although the environment can include other types and/or numbers of devices, components, elements, and communication networks 30 in other topologies and deployments. While not shown, the exemplary environment 10 may include additional components, such as database etc, which are well known to those of ordinary skill in the art and thus will not be described here. This technology provides a number of advantages including providing more effective methods, non-transitory computer readable medium and devices for managing legal documents by electronically filing, exchanging, retrieving and storing documents in civil litigation, government investigations, and multiple-claimant matters.

The data management computing device 14 assists with managing legal documents as illustrated and described with the examples herein, although data management computing device 14 may perform other types and/or numbers of functions. The data management computing device 14 includes at least one CPU/processor 18, memory 20, input device 21 and display device 22, and communication system 24 which are all coupled together by bus 26, although data management computing device 14 may comprise other types and/or numbers of elements in other configurations.

Processor(s) 18 may execute one or more computer-executable instructions stored in the memory 20 for the methods illustrated and described with reference to the examples herein, although the processor(s) can execute other types and/or numbers of instructions and perform other types and/or numbers of operations. The processor(s) 18 may comprise one or more central processing units (“CPUs”) or general purpose processors with one or more processing cores, such as AMD® processor(s), although other types of processor(s) could be used (e.g., Intel®).

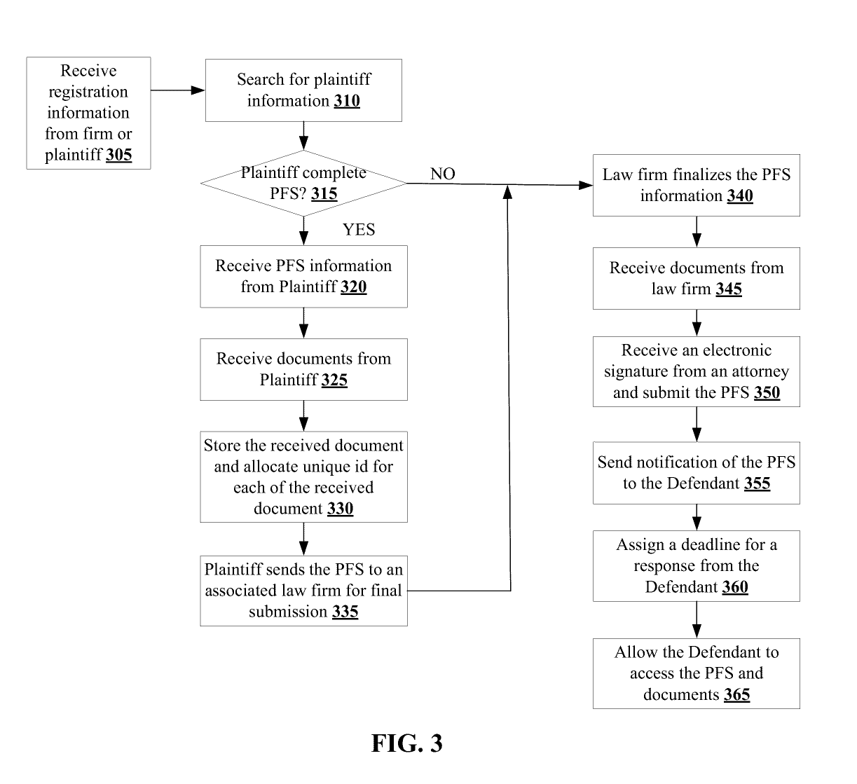

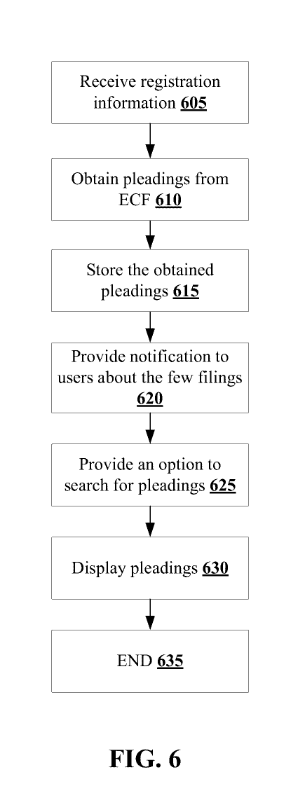

Memory 20 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIGS. 3-7 are representative of example steps or actions of this technology that may be embodied or expressed as one or more non-transitory computer or machine readable instructions stored in memory 20 that may be executed by the processor(s) 18.

Input device 21 enables a user, such as a programmer or a developer, to interact with the data management computing device 14, such as to input and/or view data and/or to configure, program and/or operate it by way of example only. By way of example only, input device 21 may include one or more of a touch screen, keyboard and/or a computer mouse.

The display device 22 enables a user, such as an administrator, to interact with the data management computing device 14, such as to input and/or view data and/or to configure, program and/or operate it by way of example only. By way of example only, the display device 22 may include one or more of a CRT, LED monitor, or LCD monitor, although other types and/or numbers of display devices could be used.

The communication system 24 in the data management computing device 14 is used to operatively couple and communicate between the data management computing device 14, the external server 16, and the plurality of consumer computing devices 12(1)-12(n), although other types and/or numbers of systems, devices, components, elements and/or networks with other types and/or numbers of connections and configurations can be used. By way of example only, the data management computing device 14 can interact with other devices via a communication network 30 such as Local Area Network (LAN) and Wide Area Network (WAN) and can use TCP/IP over Ethernet and industry-standard protocols, including NFS, CIFS, SOAP, XML, LDAP, and SNMP, although other types and/or numbers of communication networks, can be used. In this example, the bus 26 is a hyper-transport bus in this example, although other types of buses and/or other links may be used, such as PCI.

Each of the plurality of consumer computing devices 12(1)-12(n) includes a central processing unit (CPU) or processor, a memory, an interface device, input device and display device, which are coupled together by a bus or other link, although each could have other types and/or numbers of elements and/or other types and/or numbers of network devices could be used in this environment. The plurality of consumer computing devices 12(1)-12(n), in this example, may run interface applications that may provide an interface to request for managing legal documents.

Additionally as illustrated in FIG. 1, the environment 10 includes an external server 16 including a central processing unit (CPU) or processor, a memory, and a communication system, which are coupled together by a bus or other link, although other numbers and/or types of network devices could be used. Generally, the external server 16 process requests for providing court pleadings received from the plurality of consumer computing devices 12(1)-12(n), or the data management computing device 14, via the communication network 30 according to the HTTP-based application RFC protocol or the CIFS or NFS protocol in this example, but the principles discussed herein are not limited to this example and can include other application protocols. A series of applications may run on the external server 16 that allows the transmission of data requested by the plurality of consumer computing devices 12(1)-12(n), or the data management computing device 14. In this example the external server 16 may be any version of Microsoft® IIS servers or Apache® servers, although other types of servers may be used.

It is to be understood that the methods of the examples described herein are for exemplary purposes, as many variations of the specific hardware and software used to implement the examples are possible, as will be appreciated by those skilled in the relevant art(s).

Furthermore, each of the methods of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as then the non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

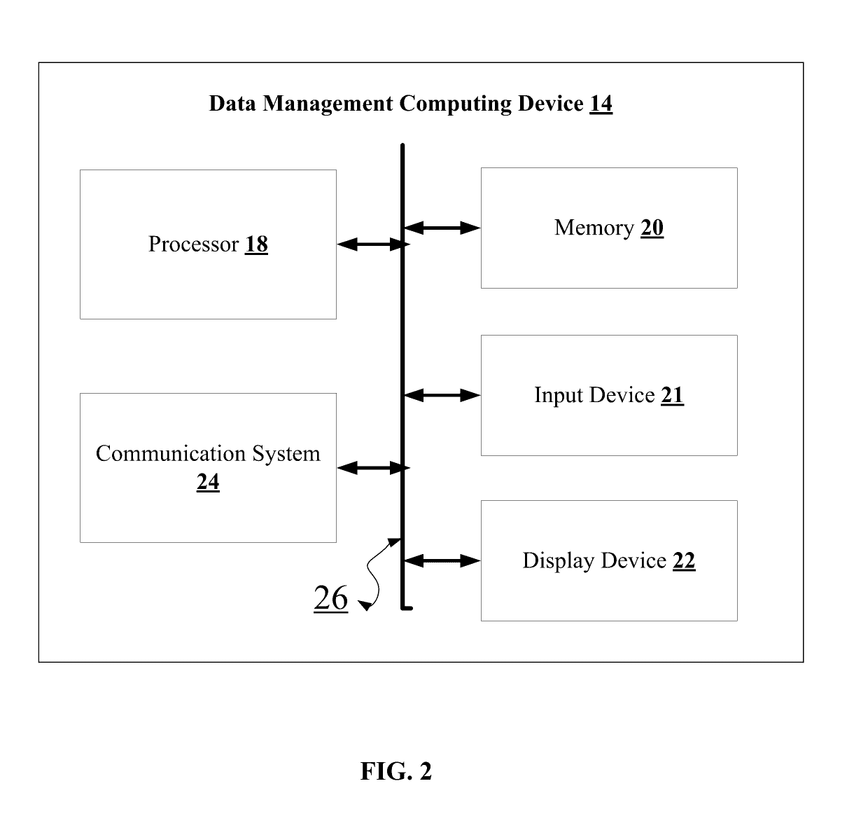

An exemplary method for managing legal documents by electronically filing, exchanging, retrieving and storing documents in civil litigation, government investigations and multiple-claimant matters will now be described with reference to FIGS. 1-7.

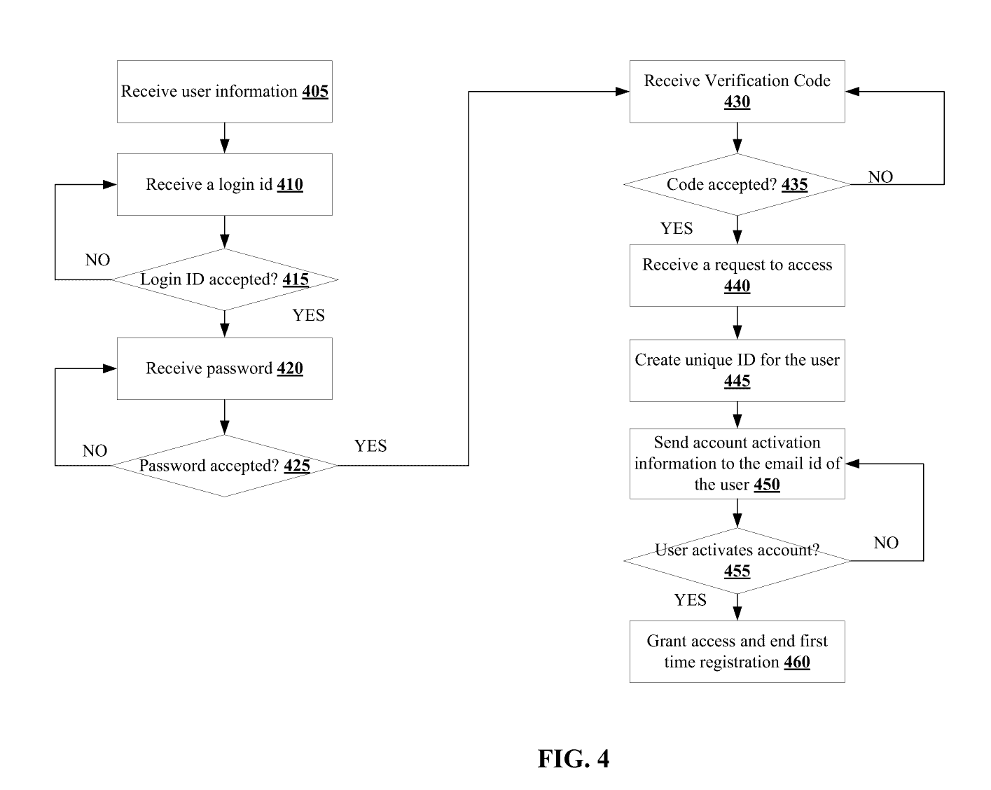

The exemplary method begins at step 305 with the data management computing device 14 receiving registration data from a law firm, or a plaintiff. Alternatively, the data management computing device 14 can also receive login data along with username and password for previously registered legal document users. In this example, the login data can be used by the plurality of consumer computing devices 12(1)-12(n) as a single sign-on to access, store, and retrieve legal documents. By way of example only, the data management computing device 14 receiving registration data and the method associated with registering first time legal document users will now be illustrated with reference to an exemplary flowchart in FIG. 4.

In step 405 of FIG. 4, the data management computing device 14 receives legal document user data, such as full legal name, date of birth, permanent address, and/or email address via one of the plurality of consumer computing devices 12(1)-12(n), although the data management computing device 14 can receive other types or amounts of data. Alternatively, if the legal document user is a law firm, the data management computing device 14 also receives data, such as the name of the law firm, address of the law firm, tax data of the law firm, and/or email address via one of the plurality of consumer computing devices 12(1)-12(n), although the data management computing device 14 can receive other types of data associated with the law firm. In yet another example, if the legal document user is an attorney representing an individual or a corporation, then the data management computing device 14 receives the data associated with the attorney such as full legal name, party represented by the attorney, attorney license details, and/or email address via one of the plurality of consumer computing devices 12(1)-12(n), although the data management computing device 14 can receive other types of data associated with the law firm. The data management computing device 14 receives similar data from other legal document users, such as the jurisdiction and name of the judge overseeing a matter, and other like information.

Next in step 410, the data management computing device 14 receives login identification data from a legal document user associated with the received legal document user data using one of the plurality of consumer computing devices 12(1)-12(n). In this example, the login identification data is used by the legal document user of one of the plurality of client computing devices 12(1)-12(n) to access the data management computing device 14 or a legal document management application executing on the data management computing device 14.

In the next step 415, the data management computing device 14 determines when the received login identification data is accepted based on one or more login identification rules. In this example, login identification rules determine if the received login identification data is compliant with either all or at least a threshold number of one or more login identification rules to be able to be determined as acceptable. By way of example only, the one or more login identification rules includes not having the full legal name as the login identification data, having at least one number or a special character and the total length of the login identification data being at least six characters, although the login identification rules can include other types or amounts of login identification rules. Accordingly, when the data management computing device 14 determines that the received login identification data is not acceptable, then the No branch is taken back to step 410 where the legal document user of one of the plurality of consumer computing devices 12(1)-12(n) is required to re-enter the login identification data.

However, when the data management computing device 14 determines that the received login identification data is accepted, then the Yes branch is taken to step 420. In step 420, the data management computing device 14 receives a password for the login identification data from one of the plurality of consumer computing devices 12(1)-12(n). In this example, the password is used along with the login identification data to be able to access the data management computing device 14 or the legal document management application executing within the data management computing device 14.

Next in step 425, the data management computing device 14 determines when the received password is accepted by comparing the received password against one or more password rules. In this example, the password rules determines when the received password is compliant with either all or at least a threshold number of one or more password rules to be able to be determined as acceptable. By way of example only, the one or more password rules includes not having the full legal name or the login identification data as the password, having at least one number or a special character and the total length of the password being at least six characters, although the password rules can include other types or amounts of password rules. Accordingly, when the data management computing device 14 determines that the received password is not acceptable, then the No branch is taken back to step 420 where the legal document user of one of the plurality of consumer computing devices 12(1)-12(n) is required to re-enter the password.

However, when the data management computing device 14 determines that the received password is accepted, then the Yes branch it taken to step 430.

In step 430, the data management computing device 14 receives a verification code from one of the plurality of consumer computing devices 12(1)-12(n). The verification code can be an alphanumeric value that is either present in the registration page displayed on the display device of one of the plurality of consumer computing devices 12(1)-12(n) for a new registration, or a verification code that is sent by the data management computing device 14. Alternatively in another example, the verification code can also be a Captcha code.

Next in step 435, the data management computing device 14 determines when the received verification code is equal to the stored verification code present in the data management computing device 14 by comparing each character of the received verification code with each character of the stored verification code. When the data management computing device 14 determines that the received verification code is not equal to the stored verification code, then the No branch is taken to back to step 430 where the data management computing device 14 requests one of the plurality of consumer computing devices 12(1)-12(n) to re-enter the code.

However, when the data management computing device 14 determines that the received verification code is accepted, then the Yes branch is taken to step 440.

In the next step 440, the data management computing device 14 receives a request to access a legal document management application executing within the data management computing device 14 from one of the plurality of consumer computing devices 12(1)-12(n). By way of example, the data management computing device 14 receives the request when one of the plurality of consumer computing devices 12(1)-12(n) clicks on a submit button after entering the verification code illustrated in the previous step.

Next in step 445, the data management computing device 14 creates a unique identification number for the received legal document user data, login identification data and the password. Additionally, the data management computing device 14 can store all of the received data and index the stored data using the created unique identification number.

In the next step 450, the data management computing device 14 sends the account activation data to the email address that was received in step 405 as part of completing the registration process to the requesting one of the plurality of consumer computing devices 12(1)-12(n). Additionally in this example, the data management computing device 14 can also send a hypertext transfer protocol (HTTP) link in the email along with the account activation data.

Next in step 455, the data management computing device 14 determines if the legal document user of one of the plurality of consumer computing devices 12(1)-12(n) has activated the legal document user registration. By way of example only, one of the plurality of consumer computing devices 12(1)-12(n) can activate the account by clicking on the HTTP link that was sent by the data management computing device 14 in the email, although the data management computing device 14 can activate the account using other techniques. In this example, when the legal document user of one of the plurality of consumer computing devices 12(1)-12(n) clicks on the HTTP link, the data management computing device 14 receives a notification from the requesting one of the plurality of consumer computing devices 12(1)-12(n). Accordingly, using this notification, the data management computing device 14 determines if the legal document user of one of the plurality of consumer computing devices 12(1)-12(n) has activated the registration. If the data management computing device determines that the legal document user of one of the plurality of client computing devices has not activated the account, then the No branch is taken back to step 450 where the data management computing device 14 again sends the HTTP link to the requesting one of the plurality of client computing devices 12(1)-12(n).

However, when the data management computing device 14 determines that the legal document user of one of the plurality of consumer computing devices 12(1)-12(n) has activated the account, then the Yes branch is taken to step 460. In step 460, the data management computing device 14 grants access to one of the plurality of consumer computing devices 12(1)-12(n) to use the legal document management application executing on the data management computing device 14 and the exemplary flow proceeds back to the flowchart illustrated in FIG. 3. Alternatively in this example, when the legal document user of one of the plurality of consumer computing devices 12(1)-12(n) is an employee of a law firm, necessary access restrictions can be applied by the data management computing device 14 for the employee to be able to access the legal document management application executing on the data management computing device 14.

In step 310 illustrated in FIG. 3, the data management computing device 14 searches for the plaintiff data based on the received new registration data or the received login data. Once the data management computing device 14 identifies the plaintiff data, only the data associated with the plaintiff such as plaintiff name, plaintiff date of birth and plaintiff tax payer ID will be displayed on the display device of the requesting one of the plurality of consumer computing devices 12(1)-12(n).

Next in step 315, the data management computing device 14 determines whether the user would like to complete the plaintiff fact sheet or other documents. In this example, the data management computing device 14 displays a question or provides an option on the display device of the requesting one of the plurality of consumer computing devices 12(1)-12(n) to check if the user would like to complete the plaintiff fact sheet or other document. Accordingly, when the data management computing device 14 determines that the user would like to complete the plaintiff fact sheet or other document, then the Yes branch is taken to step 320.

In the next step 320, the data management computing device 14 receives data from the plaintiff via one of the plurality of consumer computing devices 12(1)-12(n). In this example, the plaintiff fact sheet data includes data such as case data, product data, pharmacy data, alleged event data and other data associated with the case, investigation, or matter, although the data management computing device 14 can receive other types or amounts of data from the plaintiff as part of the fact sheet or other document. In addition, the data management computing device 14 can receive data through an import of data from an excel spreadsheet, database, or other document or source.

Next in step 325, the data management computing device 14 receives one or more documents supporting the data entered in the plaintiff fact sheet or other document from the plaintiff via one of the plurality of consumer computing devices 12(1)-12(n), although the data management computing device 14 can receive other types or amounts of documents from the plaintiff via the requesting one of the plurality of consumer computing devices 12(1)-12(n).

In the next step 330, the data management computing device 14 stores all the received one or more documents and assigns each of the received one or more documents a unique identification number that was created in step 445, although the data management computing device 14 generate a new unique identification number. In this example, the data management computing device 14 assigns the unique identification number to the documents so that they can be easily indexed and searched for future references. Using this technique, the technology is able to quickly retrieve documents associated with the plaintiff from large amounts of data actually stored in the memory 20 of the data management computing device 14.

Next in step 335, the data management computing device 14 submits the plaintiff fact sheet or other document and, upon the submission, the law firm(s) representing the plaintiff can see the plaintiff fact sheet or other document for final submission via the plurality of consumer computing devices 12(1)-12(n).

However, back in step 315, when the data management computing device 14 determines that the plaintiff would not like to complete the plaintiff fact sheet data, then the No branch is taken to step 340.

In step 340, the data management computing device 14 receives the completed the completed plaintiff fact sheet data from the law firm via the plurality of consumer computing devices 12(1)-12(n), although the data management computing device 14 can receive other types or amounts of information from the plurality of consumer computing devices 12(1)-12(n). Alternatively, the plaintiff fact sheet can be prepopulated or completed using case related data such as filed lawsuits, case caption, case number, date of filing, or other types of data point associated with the case, which are all stored in the memory 20, although the data management computing device 14 can use other types or amounts of information to prepopulate or complete the plaintiff fact sheet.

Next in step 345, the data management computing device 14 receives one or more documents from the law firm(s) representing the plaintiff via one of the plurality of consumer computing devices 12(1)-12(n). Additionally, the data management computing device 14 assigns a unique identification number that was generated in step 445 to each of the received documents, and stores the received documents from the law firm(s) via one of the plurality of consumer computing devices 12(1)-12(n).

Once the plaintiff fact sheet is completed and the necessary documents have been received, in step 350 the data management computing device 14 receives an electronic signature from an attorney in the law firm(s) representing the plaintiff via the input device 21 of the data management computing device 14, although the data management computing device 14 can receive the electronic signature via the input devices on one of the plurality of consumer computing devices 12(1)-12(n). Then the data management computing device 14 proceeds to submit the plaintiff fact sheet data. Alternatively prior to submitting the plaintiff fact sheet data, the data management computing device 14 assists with reviewing of all the data in the plaintiff fact sheet and the received necessary documents. By way of example, the defendants or neutral party can review the data in the plaintiff fact sheet via the display device 22, although the data in the plaintiff fact sheet can be reviewed using the plurality of consumer computing devices 12(1)-12(n). While reviewing the data in the plaintiff fact sheet, the data management computing device 14 can receive the reason for the deficiency in the data in the plaintiff fact sheet via the input device 21 or the plurality of consumer computing devices 12(1)-12(n). The data management computing device 14 uses the received reason and converts that to notification and sends out the data deficiency notification to the plurality of consumer computing devices 12(1)-12(n). Furthermore in this example, the received documents and the plaintiff fact sheet can only be submitted only when the data deficiency notification has been resolved by correcting the deficient data in the plaintiff fact sheet. Additionally, the received documents can be placed in multiple memory queues by the data management computing device 14 to assist with enforcing quality control checks and efficient memory management.

In the next step 355, upon submitting the plaintiff fact sheet or other document, the data management computing device 14 sends a notification to the plurality of consumer computing devices 12(1)-12(n) used by defendants. By way of example only, the notification can include an email message, although the data management computing device 14 can send out other types of notification.

Next in step 360, the data management computing device 14 assigns a deadline for a response back from the plurality of consumer computing devices 12(1)-12(n) used by the defendants. By way of example only, the data management computing device 14 assigns the deadline to the requested response based on one or more rules set forth by the court, although the data management computing device 14 can set the deadline based on other parameters. Additionally in this example, the data management computing device 14 also sends out constant reminders to the plurality of consumer computing devices 12(1)-12(n) when the current date gets closer to the assigned deadline date.

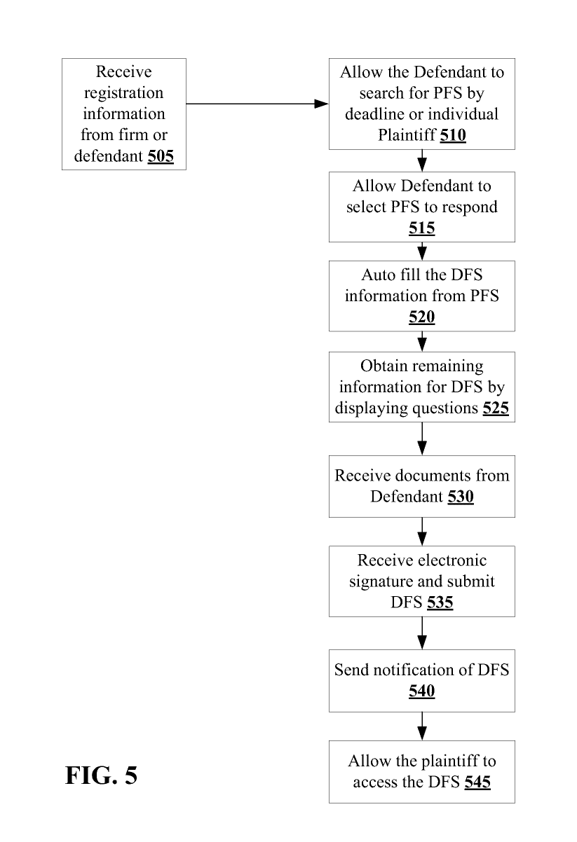

In the next step 365, the data management computing device 14 allows the defendant using one of the plurality of consumer computing devices 12(1)-12(n) to access plaintiff fact sheet and the documents to send a defendant fact sheet or other response. The defendant preparing and sending a response will be further illustrated with reference to FIG. 5.

In step 505, the data management computing device 14 receives registration data from a law firm, or a defendant. Alternatively, the data management computing device 14 can also receive login data along with username and password for previously registered legal document users. In this example, the login data can be used by the plurality of consumer computing devices 12(1)-12(n) as a single sign-on to access, store, and retrieve legal documents. By way of example only, the data management computing device 14 receiving registration data and the method associated with registering first time legal document users is similar to the above illustration of FIG. 4.

In step 510, the data management computing device 14 allows the defendant using one of the plurality of consumer computing devices 12(1)-12(n) to search for plaintiff fact sheet or other document by deadline or based on an individual plaintiff. In this example, the data management computing device 14 displays a form with fields on the display device of the requesting one of the plurality of consumer computing devices 12(1)-12(n) that includes options which can be used by the defendant to search for the plaintiff fact sheet or other document.

In the next step 515, the data management computing device 14 allows the defendant to select one of the plurality of plaintiff fact sheets or other documents that are available within the legal document management application executing within the data management computing device 14.

Next in step 520, based on the received selection of the plaintiff fact sheet or other document, the data management computing device 14 automatically fills a portion of the defendant fact sheet or other document from the data present in the selected plaintiff fact sheet or other document. By way of example only, the defendant fact sheet and the plaintiff fact sheet can include one or more common fields and therefore the data management computing device 14 assists the defendant with automatically filling out the common fields with the data from the plaintiff fact sheet.

In the next step 525, the data management computing device 14 obtains the remaining data on the defendant fact sheet or other document from the defendant using one of the plurality of consumer computing devices 12(1)-12(n) by displaying questions on the display device of the plurality of consumer computing devices or by receiving an import of data from a spreadsheet or other document.

Next in step 530, the data management computing device 14 receives one or more defendant documents supporting the data entered in the defendant fact sheet or other document from the defendant via one of the plurality of consumer computing devices 12(1)-12(n), although the data management computing device can received the defendant documents using other techniques. Additionally, the data management computing device 14 stores and assigns a unique identification number to each of the received documents from the defendant.

Next in step 535, the data management computing device 14 receives an electronic signature from an attorney of a law firm(s) representing the defendant via the input device 21 of data management computing device 14 and submits the defendant fact sheet or other document. Alternatively, the data management computing device 14 can also assist with reviewing the data in the defendant fact sheet and the received documents using the technique illustrated above in step 350, although other techniques can be used to assist with reviewing the data.

Upon submitting the defendant fact sheet or other document, in step 540, the data management computing device 14 sends a notification of the submission of the defendant fact sheet or other document to the one of the plurality of consumer computing devices used by the Plaintiff.

In the next step 545, the data management computing device 14 allows the Plaintiff to view the defendant fact sheet or other document.

In step 605, the data management computing device 14 receives registration data from a law firm, a defendant, or a plaintiff, or a judge or other types of legal documents users. Alternatively, the data management computing device 14 can also receive login data along with username and password for previously registered legal document users. In this example, the login data can be used by the plurality of consumer computing devices 12(1)-12(n) as a single sign-on to access, store, and retrieve legal documents. By way of example only, the data management computing device 14 receiving registration data and the method associated with registering first time legal document users is similar to the above illustration of FIG. 4. Additionally in this example, the data management computing device 14 also receives data relating to the court pleadings that are required to be obtained along with the registration data, although the data management computing device 14 can receive other types or amounts of information.

Next in step 610, the data management computing device 14 obtains all the pleadings from an external server 16 based on the received court pleadings data for documents filed through the United States government PACER system which sends email notifications via Electronic Case Filing notifications (ECF), which are automatically processed and downloaded without any human intervention, although the data management computing device 14 can obtain the pleadings from other locations or sources. Alternatively, the data management computing device can obtain all the available pleadings from the external server 16, or the data management computing device can only obtain the most recent pleadings (between two dates) from the external server 16. Documents can be retrieved through an automated process that does not require documents to be downloaded, and can also be retrieved individually and uploaded by an administrative user using the data management computing device 14.

Next in step 615, the data management computing device 14 stores all the obtained pleadings within the memory 20 of the data management computing device 14, although the data management computing device 14 can store the obtained pleadings at other memory locations.

In the next step 620, the data management computing device 14 provides a notification regarding the availability of the obtained pleadings to all the registered legal document users of the legal document management application that is executing on the data management computing device 14.

Next in step 625, the data management computing device 14 provides searching capabilities to legal document users of the plurality of consumer computing devices 12(1)-12(n) to search a particular pleading in the obtained pleadings. By way of example only, the data management computing device 14 provides the option of searching the pleadings based on the document ID, document number, document name, filer name, data filed and/or specific text within the pleadings or record stored at the external server 16, although the data management computing device 14 can provide other searching options to the plurality of consumer computing devices 12(1)-12(n) registered to access the legal document management application executing on the data management computing device 14.

Next in step 630, when the data management computing device 14 receives a selection of one or more of the displayed pleadings, it displays the received selection of the pleadings on the display device of the requesting one of the plurality of consumer computing devices 12(1)-12(n) and the exemplary method for searching for pleadings ends at step 635.

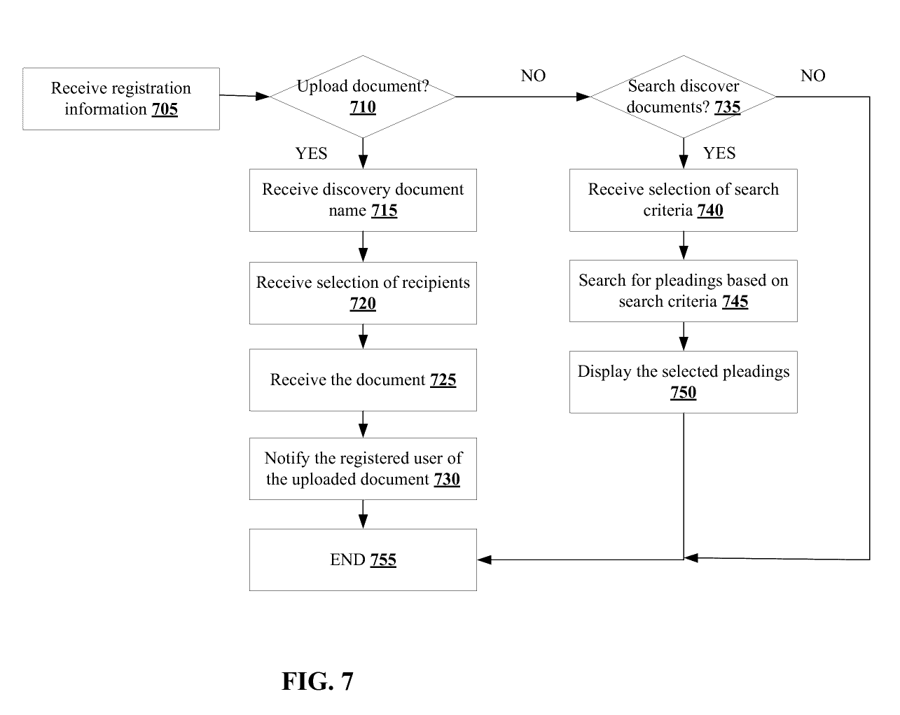

Now an exemplary method for processing discovery requests will now be illustrated with reference to FIG. 7. In step 705, the data management computing device 14 receives registration data from a law firm, a defendant, or a plaintiff, or a judge or other types of legal documents users. Alternatively, the data management computing device 14 can also receive login data along with username and password for previously registered legal document users. In this example, the login data can be used by the plurality of consumer computing devices 12(1)-12(n) as a single sign-on to access, store, and retrieve legal documents. By way of example only, the data management computing device 14 receiving registration data and the method associated with registering first time legal document users is similar to the above illustration of FIG. 4.

In step 710, the data management computing device 14 determines whether the requesting one of the plurality of consumer computing devices 12(1)-12(n) wants to upload a document either to exchange as part of a discovery process or to store in a virtual repository that is accessible to specified users. In this example, the data management computing device 14 makes this determination by displaying a question on the display device of the requesting one of the plurality of client computing devices 12(1)-12(n), although the data management computing device 14 can use other techniques to make the determination. Accordingly, when the data management computing device 14 determines that the requesting one of the plurality of consumer computing devices 12(1)-12(n) wants to upload a document, then the Yes branch is taken to step 715.

In step 715, the data management computing device 14 receives the name of the document that is being uploaded from the requesting one of the plurality of consumer computing devices 12(1)-12(n). By way of example only, the received name of the document can include alphanumeric characters.

Next in step 720, the data management computing device 14 receives a selection of the recipients to whom the notification regarding the availability of the document is to be sent out, which is received from the requesting one of the plurality of consumer computing devices 12(1)-12(n), although the data management computing device 14 can receive other types or amounts of data.

In step 725, the data management computing device 14 receives the actual document from the requesting one of the plurality of consumer computing devices 12(1)-12(n).

Next in step 730, the data management computing device 14 sends a notification, which can be by e-mail or other methods, to all the recipients that were initially received from the requesting one of the plurality of consumer computing devices 12(1)-12(n) indicating the availability of the document. Additionally, the data management computing device 14 can also store the received document in the memory 20 of the data management computing device 14, although the document can be stored at other memory locations and the exemplary method ends at step 755.

However, back in step 710, if the data management computing device 14 determines that the requesting one of the plurality of consumer computing devices 12(1)-12(n) does not want to upload the document, then the No branch is taken to step 735.

In step 735, the data management computing device 14 determines when the requesting one of the plurality of consumer computing devices 12(1)-12(n) wants to search for stored documents by displaying a question on the display device of the requesting one of the plurality of consumer computing devices 12(1)-12(n). When the data management computing device 14 determines that the requesting one of the plurality of consumer computing devices 12(1(0-12(n) does not want to search for stored documents, then the No branch is taken to end the exemplary method at step 755. However, when the data management computing device 14 determines that the requesting one of the plurality of consumer computing devices 12(1)-12(n) wants to search for stored documents, then the Yes branch is taken to step 740.

In step 740, the data management computing device 14 receives a selection of search criteria from the requesting one of the plurality of consumer computing devices 12(1)-12(n). By way of example only, the search criteria can include data such as document name, document ID, date of document served, and/or the filer name, although the data management computing device 14 can receive other types or amounts of search criteria.

Next in step 745, based on the received search criteria, the data management computing device 14 searches and displays all the stored documents that match either a threshold number of, or all search criteria.

In step 750, the data management computing device 14 receives a selection of displayed stored documents which the data management computing device 14 displays on the display device of the requesting one of the plurality of consumer computing devices 12(1)-12(n) and the exemplary method ends at step 755.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

What is claimed is:

1. A method for managing legal documents, the method comprising:
receiving, by a data management computing device, data in a legal fact sheet from a consumer computing device;
receiving, by the data management computing device, one or more supporting legal documents associated with the received data in the fact sheet;
determining, by the data management computing device, when the received data in the legal fact sheet and the received one or more supporting legal documents are complete and accurate based on review data received from the consumer computing device; and
sending, by the data management computing device, a completion notification and a request for a response to the data in the legal fact sheet to the consumer computing device when the received data in the legal fact sheet and the received one or more supporting legal documents are determined to be complete and accurate, wherein the sending comprises generating and providing summary reports comprising the data in the legal fact sheet.

2. The method as set forth in claim 1 further comprising:
receiving, by the data management computing device, registration data associated with a legal user;
determining, by the data management computing device, a type of the legal user based on the received registration data; and
providing, by the data management computing device, one or more document management rights to the legal user based on the determined type.

3. The method as set forth in claim 1 wherein the receiving further comprises importing, by the data management computing device, the data into the legal fact sheet from a legal document associated with the legal user.

4. The method as set forth in claim 1 wherein the determining further comprises:
obtaining, by the data management computing device, additional data required to complete the legal fact sheet when the received data in the legal fact sheet and the received one or more supporting legal documents are determined not to be complete and accurate based on review data received from the consumer computing device;
obtaining, by the data management computing device, one or more additional supporting documents associated with the obtained additional data; and
sending, by the data management computing device, the completion notification upon obtaining the additional data and the one or more additional supporting documents.

5. The method as set forth in claim 1 further comprising:
obtaining, by the data management computing device, one or more court pleadings from an external server;
identifying, by the data management computing device, one or more new court filings from the obtained one or more court pleadings; and
sending, by the data management computing device, a new court filing notification based on the identified one or more new court filings.

6. The method as set forth in claim 1 further comprising:
receiving, by the data management computing device, one or more search criteria to identifying at least one discovered document from a plurality of discovered documents;
identifying, by the data management computing device, the at least one discovered document from the plurality of discovered documents based on the received one or more search criteria; and
providing, by the data management computing device, the identified at least one discovered document to the consumer computing device.

7. A non-transitory computer readable medium having stored thereon instructions for managing legal documents comprising machine executable code which when executed by at least one processor, causes the processor to perform steps comprising:
receiving data in a legal fact sheet from a consumer computing device;
receiving one or more supporting legal documents associated with the received data in the fact sheet;
determining when the received data in the legal fact sheet and the received one or more supporting legal documents are complete and accurate based on review data received from the consumer computing device; and
sending a completion notification and a request for a response to the data in the legal fact sheet to the consumer computing device when the received data in the legal fact sheet and the received one or more supporting legal documents are determined to be complete and accurate, wherein the sending comprises generating and providing summary reports comprising the data in the legal fact sheet.

8. The medium as set forth in claim 7 further comprising:
receiving registration data associated with a legal user;
determining a type of the legal user based on the received registration data; and
providing one or more document management rights to the legal user based on the determined type.

9. The medium as set forth in claim 7 wherein the receiving further comprises importing the data into the legal fact sheet from a legal document associated with the legal user.

10. The medium as set forth in claim 7 wherein the determining further comprises:
obtaining additional data required to complete the legal fact sheet when the received data in the legal fact sheet and the received one or more supporting legal documents are determined not to be complete and accurate based on review data received from the consumer computing device;
obtaining one or more additional supporting documents associated with the obtained additional data; and
sending the completion notification upon obtaining the additional data and the one or more additional supporting documents.

11. The medium as set forth in claim 7 further comprising:
obtaining one or more court pleadings from an external server;
identifying one or more new court filings from the obtained one or more court pleadings; and
sending a new court filing notification based on the identified one or more new court filings.

12. The medium as set forth in claim 7 further comprising:
receiving one or more search criteria to identifying at least one discovered document from a plurality of discovered documents;
identifying the at least one discovered document from the plurality of discovered documents based on the received one or more search criteria; and
providing the identified at least one discovered document to the consumer computing device.

13. A data management computing device comprising:
one or more processors coupled to a memory and configured to be capable of executing programmed instructions comprising and stored in the memory to:
receive data in a legal fact sheet from a consumer computing device;
receive one or more supporting legal documents associated with the received data in the fact sheet;
determine when the received data in the legal fact sheet and the received one or more supporting legal documents are complete and accurate based on review data received from the consumer computing device; and
send a completion notification and a request for a response to the data in the legal fact sheet to the consumer computing device when the received data in the legal fact sheet and the received one or more supporting legal documents are determined to be complete and accurate, wherein the sending comprises generating and providing summary reports comprising the data in the legal fact sheet.

14. The device as set forth in claim 13 wherein the one or more processors are further configured to be capable of executing one or more additional programmed instructions comprising and stored in the memory to:
receive registration data associated with a legal user;
determine a type of the legal user based on the received registration data; and
provide one or more document management rights to the legal user based on the determined type.

15. The device as set forth in claim 13 wherein the one or more processors are further configured to be capable of executing one or more additional programmed instructions comprising and stored in the memory to the receiving further comprises import the data into the legal fact sheet from a legal document associated with the legal user.

16. The device as set forth in claim 13 wherein the one or more processors are further configured to be capable of executing one or more additional programmed instructions comprising and stored in the memory to the determining further comprises:
obtain additional data required to complete the legal fact sheet when the received data in the legal fact sheet and the received one or more supporting legal documents are determined not to be complete and accurate based on review data received from the consumer computing device;
obtain one or more additional supporting documents associated with the obtained additional data; and
send the completion notification upon obtaining the additional data and the one or more additional supporting documents.

17. The device as set forth in claim 13 wherein the one or more processors are further configured to be capable of executing one or more additional programmed instructions comprising and stored in the memory to:
obtain one or more court pleadings from an external server;
identify one or more new court filings from the obtained one or more court pleadings; and
send a new court filing notification based on the identified one or more new court filings.

18. The device as set forth in claim 13 wherein the one or more processors are further configured to be capable of executing one or more additional programmed instructions comprising and stored in the memory to:
receive one or more search criteria to identifying at least one discovered document from a plurality of discovered documents;
identify the at least one discovered document from the plurality of discovered documents based on the received one or more search criteria; and
provide the identified at least one discovered document to the consumer computing device.
